(19) United States
(12) Patent Application Publication
(10) Pub. No.: US 2012/0188856 A1
(43) Pub. Date: Jul. 26, 2012

(54) Electronic apparatus, timepiece device and program

(76) Inventor: Keisuke Tsubata, Chiba-shi (JP)

(21) Appl. No.: 13/374,873

(22) Filed: Jan. 19, 2012

(30) Foreign Application Priority Data
Jan. 20, 2011 (JP) 2011-010070

(51) Int. Cl. G04F 10/00

(52) U.S. Cl. 368/107

(57) ABSTRACT

Provided is a timepiece device that includes a first time measurement portion which measures an elapsed time from a first timekeeping start operation; and a second time measurement portion which measures an elapsed time from a second timekeeping start operation, wherein a time measured by the first time measurement portion, and a time, which is a time measured by the second time measurement portion subtracted from an object time, are displayed on the display portion in a combined manner.

### BACKGROUND OF THE INVENTION

1. Field of the Invention

The present invention relates to an electronic apparatus, a timepiece device and a program.

2. Background Art

In stopwatches used for timekeeping in athletic sports or the like, there is a stopwatch which displays a necessary time (a split time) from the start of timekeeping to the present and is able to set a time (a target time; an object time), which is expected to be spent in running of a section (a lap), for a plurality of sections in advance. With such stopwatches, a stopwatch is known which notifies the user of the passage of the target time by performing sound notification or the like whenever the target time elapses. A user can know whether an actual running proceeds in a preset time or is delayed by setting the target time for the section in which a distance can be known during running.

JP-UM-B-06-28718 describes that, upon inputting a first target time in a stopwatch, a value of an integral multiplication of the first target time is automatically set as a second target time thereafter.

JP-A-09-72973 describes that the target time of the previous section is displayed as an initial value when setting and operating the next lap time, in the stopwatch.

However, in the related art described in JP-UM-B-06-28718 and JP-A-09-72973, it is difficult to know a remaining time that is a standard until reaching the next object point. For example, in the stopwatch of the related art, a user starts a timer that is in a mode different from that of the stopwatch mode when passing through a starting point (a lap point) of a new lap such as when starting or when passing through a 5 km point. Furthermore, a user confirms an elapsed time (a lap elapsed time) from the lap point passage while changing the stopwatch mode and the timer mode. However, in such a usage method, there is a need for a cumbersome button operation during running, and it is difficult to simultaneously know a split time and a remaining time (a remaining target time) of the object time up to the next lap point.

### SUMMARY OF THE INVENTION

It is an aspect of the present application to provide an electronic apparatus, a timepiece device, and a program that simultaneously display the split time and the remaining time up to the object time.

(1) According to another aspect of the present application, there is provided a timepiece device that includes a first time measurement portion which measures an elapsed time from a first timekeeping start operation, and a second time measurement portion which measures an elapsed time from a second timekeeping start operation, wherein a time measured by the first time measurement portion, and a time, which is a time measured by the second time measurement portion subtracted from an object time, are displayed on the display portion in a combined manner.

(2) Furthermore, According to another aspect of the present application, the first time measurement portion and the second time measurement portion may simultaneously start the timekeeping.

(3) Furthermore, according to another aspect of the present application, the second time measurement portion may start a new timekeeping simultaneously with an ending operation of the timekeeping.

(4) Furthermore, according to another aspect of the present application, when the time, which is the time measured by the second time measurement portion subtracted from the preset time, is a negative value, the time, which is the time measured by the second time measurement portion subtracted from the preset time, may be displayed as the negative value.

(5) Furthermore, according to another aspect of the present application, the second time measurement portion may start a new timekeeping when the preset time elapses.

(6) Furthermore, according to another aspect of the present application, a value, which is a sum of the times measured by the second time measurement portion subtracted from a sum of the preset times, may be displayed.

(7) Additionally, according to another aspect of the present application, there is provided an electronic apparatus including the timepiece device mentioned above.

(8) Furthermore, according to still another aspect of the present application, there is provided a program for causing a computer of the timepiece device to execute first time measurement means for measuring a time elapsed from a first timekeeping start operation, second time measurement means for measuring a time elapsed from a second timekeeping start operation, and means for displaying a time measured by the first time measurement portion and a time, which is a time measured by the second time measurement portion subtracted from an object time, on the display portion in a combined manner.

According to the present application, it is possible to simultaneously know the elapsed time from the start and the remaining time up to the object set time.

### BRIEF DESCRIPTION OF THE DRAWINGS

FIG. 1 is a diagram that shows an exterior of a stopwatch according to a first embodiment of the present invention.

FIG. 2 is a schematic block diagram that shows a configuration of the stopwatch according to the present embodiment.

FIG. 3 is a functional block diagram of an inner portion of a CPU in the stopwatch according to the present embodiment.

FIG. 4 is a diagram that shows an example of a relationship between an operation in the stopwatch according to the present embodiment and an operation of a user.

FIG. 5 is a diagram that shows an example of a data structure stored in a RAM in the stopwatch according to the present invention.

FIG. 6 is a flowchart that shows an example of the operation in the stopwatch according to the present embodiment.

FIG. 7 is a diagram that shows an example of a display in the stopwatch according to the present embodiment.

FIG. 8 is a diagram that shows another example of the display in the stopwatch according to the present embodiment.

FIG. 9 is a diagram that shows still another example of the display in the stopwatch according to the present embodiment.

FIG. 10 is a flowchart that shows an example of the operation in the stopwatch according to a second embodiment of the present invention.

### DETAILED DESCRIPTION OF THE INVENTION

### First Embodiment

Hereinafter, a first embodiment of the present invention will be described in detail with reference to the drawings.

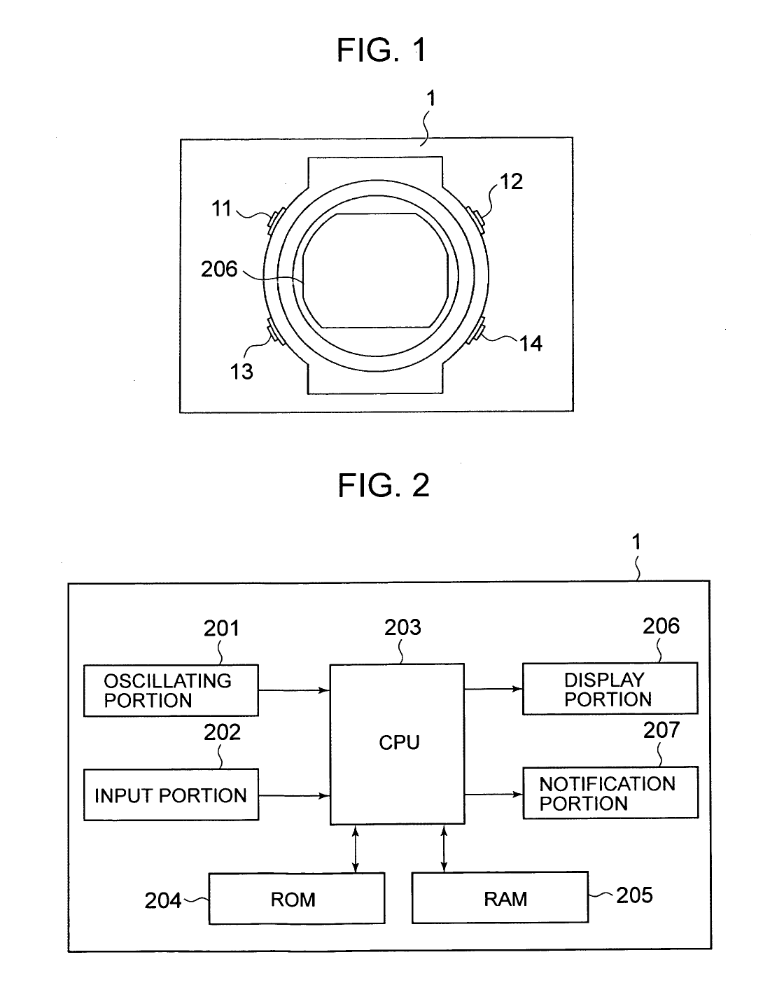

FIG. 1 is an exterior diagram that shows an exterior of a stopwatch 1 according to a first embodiment of the present invention. In the example shown, the stopwatch 1 (a timepiece device) includes buttons 11 to 14, and a display portion 206.

A button 11 is used for the input of a start, a stop and a reset of the timekeeping from a user.

A button 12 is used for the input of information indicating a passage of a lap point from the user.

A button 13 is used for the input of a change in display mode from a user.

A button 14 is used for the input of a change in operation mode (a stopwatch mode, a usual timepiece mode, a timer mode, a world timepiece mode or the like) from a user.

Furthermore, a combination of the buttons 11 to 14 is also used in the input of a running object time (a target time) between the lap points.

A display portion 206 includes a display element such as a liquid crystal panel and displays a measured time, setting information of each mode or the like.

FIG. 2 is a schematic block diagram that shows a configuration of the stopwatch 1 according to a first embodiment of the present invention. In the example shown, the stopwatch 1 includes an oscillating portion 201, an input portion 202, a CPU (Central Processing Unit) 203, a Read Only Memory (ROM) 204, a Random Access Memory (RAM) 205, a display portion 206, and a notification, portion 207.

The oscillating portion 201 divides the signal output from an oscillating element such as a crystal vibrator, and creates and outputs a clock signal with a frequency suitable for the operation of the CPU 203.

The input portion 202 receives the input from a user. For example, when a user wants to perform the start, the stop, the lap, the target time setting, the operation mode, or the switching of the screen display of the stopwatch 1, a user performs the input by the use of buttons 11 to 14 provided in the stopwatch 1. The input portion 202 outputs the signal depending on the input to the CPU 203. For example, when the switch 12 is depressed, the input portion 202 outputs the signal indicating the passage of the lap point to the CPU 203.

The CPU 203 performs various process operations in synchronization with the clock signal that is output from the oscillating portion 201. Information is input from the input portion 202 to the CPU 203. The CPU 203 reads the program from the ROM 204. The CPU 203 writes and reads the data or the like, which is temporarily used in the inner portion, to the RAM 205. The CPU 203 displays the measured time, the setting information of each mode or the like on the display portion 206. The CPU 203 notifies the notification portion 207 that the time has been reached.

Data other than the program is written on the ROM 204.

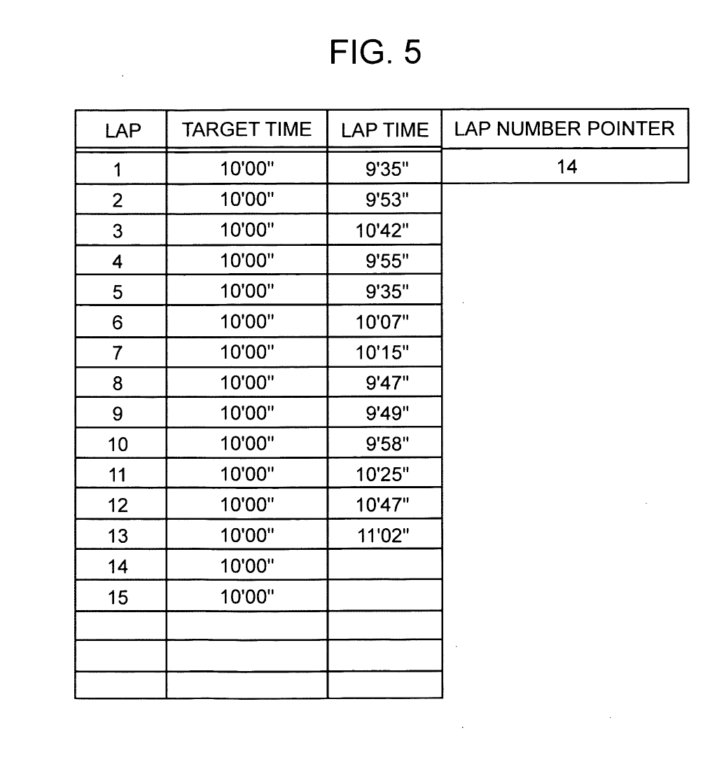

The RAM 205 writes and reads the data created by the CPU 203, a lap number pointer showing which number the current lap is, a target time, a lap time of each lap described using FIG. 5 shown below or the like, from the CPU 203.

The command from the CPU 203 is input to the notification portion 207, and the notification portion 207 notifies a user that a preset time has been reached by sound notification, vibration or the like.

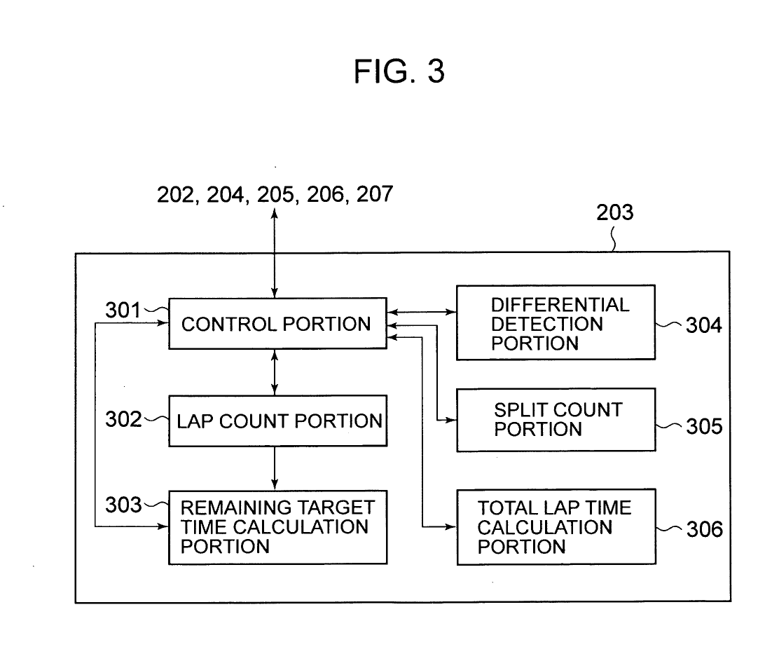

FIG. 3 is a schematic block diagram that shows configurations of each portion that performs the process in the inner portion of the CPU 203. In the example shown in the FIG. 3, a control portion 301, a lap count portion 302, a remaining target time calculation portion 303, a differential detection portion 304, a split count portion 305, and a total lap time calculation portion 306 are included.

The control portion 301 performs the initialization and the starting of the lap count portion (a second time measurement portion) 302, the remaining target time calculation portion 303, the differential detection portion 304, the split count portion (a first time measurement portion) 305, and the total lap lime calculation portion 306, the exchange of data with each portion or the like. The control portion 301 reads the target times and the lap time of each section written on the RAM 205, and outputs the same to the differential detection portion 304 and the total lap time calculation portion 306. The control portion 301 outputs the command to start timekeeping to the split count portion 305. The control portion 301 outputs the command, which outputs the split time to the control portion 301, to the split count portion 305. The control portion 301 reads the lap time written on the RAM 205, and outputs the read lap time to the total lap time calculation portion 306. The control portion 301 outputs a command, which outputs the total lap time, to the total lap time calculation portion 306.

The control portion 301 performs the process of the data input and output with the input portion 202, the ROM 204, the RAM 205, the display portion 206, and the notification portion 207.

The command to start the timekeeping from the control portion 301 is input to the lap count portion 302, and the lap count portion 302 starts the timekeeping. When starting the timekeeping, the lap count portion 302 erases the time data that is being measured, and the time data is counted up from 0. Furthermore, the lap count portion 302 can set an initial value of the time data from the control portion 301 upon starting the count and perform the counting-up from the initial value. The lap elapsed time from the control portion 301 is input to the lap count portion 302 or the command, which outputs the lap time to the control portion 301 or the remaining target time calculation portion 303, is input to the lap count portion 302, whereby the lap count portion 302 outputs the lap elapsed time and the lap time to the control portion 301 and outputs the lap elapsed time to the remaining target time calculation portion 303.

The target time is input from the control portion 301 to the remaining target time calculation portion 303 and the lap elapsed time is input from the lap count portion 302 to the remaining target time calculation portion 303.

The remaining target time calculation portion 303 calculates a value (the remaining target time) that subtracts the lap elapsed time from the target time. A command, which outputs the remaining target time to the control portion 301, is input from the control portion 301 to the remaining target time calculation portion 303. The remaining target time calculation portion 303 outputs the calculated remaining target time to the control portion 301.

The target times and the lap times of each section written on the RAM 205 are input to the differential detection portion 304 through the control portion 301. The differential detection portion 304 calculates a total lap time of the respective counted laps and a total target time of the target times corresponding to the respective laps. The differential detection portion 304 calculates a differential (multiple lap differentials) between the total lap time and the total target time. The command, which outputs the multiple lap differentials to the control portion 301, is input from the control portion 301 to the differential detection portion 304. The differential detection portion 304 outputs the plurality of calculated lap differentials to the control portion 301.

The command to start timekeeping is input from the control portion 301 to split count portion 305 to start the timekeeping. The command, which outputs the split time from the control portion 301 to the control portion 301, is input to the split count portion 305. The split count portion 305 outputs the calculated split time to the control portion 301.

The lap times of each section, which are written on the RAM 205 and are counted until that time, are input from the control portion 301 to the total lap time calculation portion 306. The total lap time calculation portion 306 calculates the total lap time of the respective counted laps. The command, which outputs the total lap time, is input from the control portion 301 to the total lap time calculation portion 306. The total lap time calculation portion 306 outputs the calculated total lap time to the control portion 301.

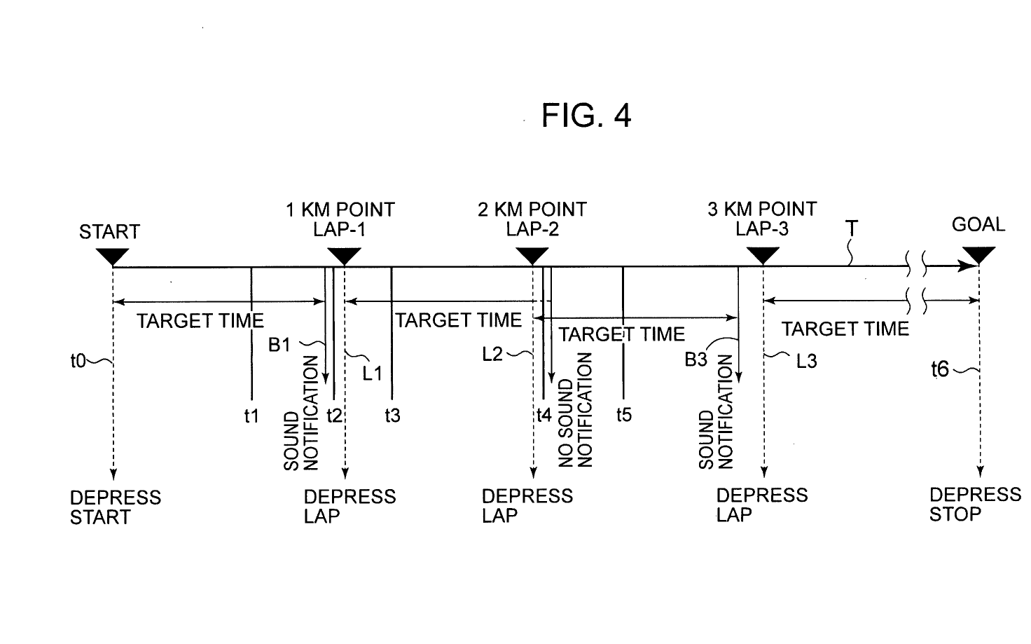

FIG. 4 is a diagram that shows an example of a relationship between the motion of the stopwatch 1 and the operation of a user in the present embodiment. T indicates a time axis and shows that the time proceeds rightward. A user presses the button 11 (the start) at a time t0 and starts the timekeeping. At this time, the stopwatch 1 starts the timekeeping of the split time by the use of the split count portion 305, and starts the timekeeping of the lap elapsed time by the use of the lap count portion 302. That is, the keeping of the split time and the keeping of the lap elapsed time are simultaneously started. The display portion 206 displays the current split time, the lap elapsed time, the remaining target time or the like.

FIG. 4 shows a case where a user is unable to reach LAP-1 that is 1 km point within the target time. For that reason, before a user reaches LAP-1, the sound notification B1 is provided. In addition, even after the sound notification is provided, the keeping of the lap elapsed time is continued. A user presses the button 12 (the lap point passage) when reaching LAP-1. As a result, the stopwatch 1 finishes the keeping of the lap elapsed time, and stores the lap time in the RAM 205. In addition, the lap time refers to the lap elapsed time at the point of time when the lap button 12 is depressed and the lap count portion 302 stops the timekeeping. Next, the stopwatch 1 starts the timekeeping of a new lap elapsed time from a time t2. In addition, the split count portion 305 continues the started timekeeping.

A user presses the button 12 when reaching a point of LAP-2. As a result, the stopwatch 1 finishes the keeping of the lap elapsed time and stores the lap time in the RAM 205. After that the measurement of a new lap elapsed time is started. Since a user reaches the point of LAP-2 before the target time elapses, the sound notification is not provided when the target time started at the point of LAP-1 elapses.

An operation by a user at a point of LAP-3 is identical to the operation by a user at the point of LAP-1. Furthermore, the motion of the stopwatch 1 at the point of LAP-3 is identical to the motion of the stopwatch 1 at the point of LAP-1. In this manner, the motion of the stopwatch 1 and the operation of a user are repeated in each lap. Finally, the motion and the operation of the stopwatch 1 of the case concerning a goal point will be described. When reaching a goal point (t6), a user presses the button 11 (stop) to stop the keeping of the stopwatch 1. At this time, the stopwatch 1 stops the keeping of the split time and the lap elapsed time, and stores the lap time in the RAM 205.

FIG. 5 is a table that shows an example of a relationship between the target times and the lap times of each lap.

As shown in FIG. 5, numbers, target times, and lap times related to the LAP are associated with each other. A first column is a number related to each lap. A second column is a target time. A third column is a time (a lap time) that is actually spent in each lap. A fourth column is a lap number pointer which is a value showing which lap is currently being counted. In the present example, a case is shown where the target times are 15 sections and the current lap is a fourteenth lap. Information indicated in this table is recorded on the RAM 205. The target time is used when calculating the remaining target time in a remaining target time calculation portion 303. Furthermore, the lap time is used to calculate the multiple lap differentials or a total lap time which is a sum of the lap times up to a certain number of laps, in the differential detection portion 304.

Next, an example of the motion of the stopwatch 1 in the present embodiment will be described.

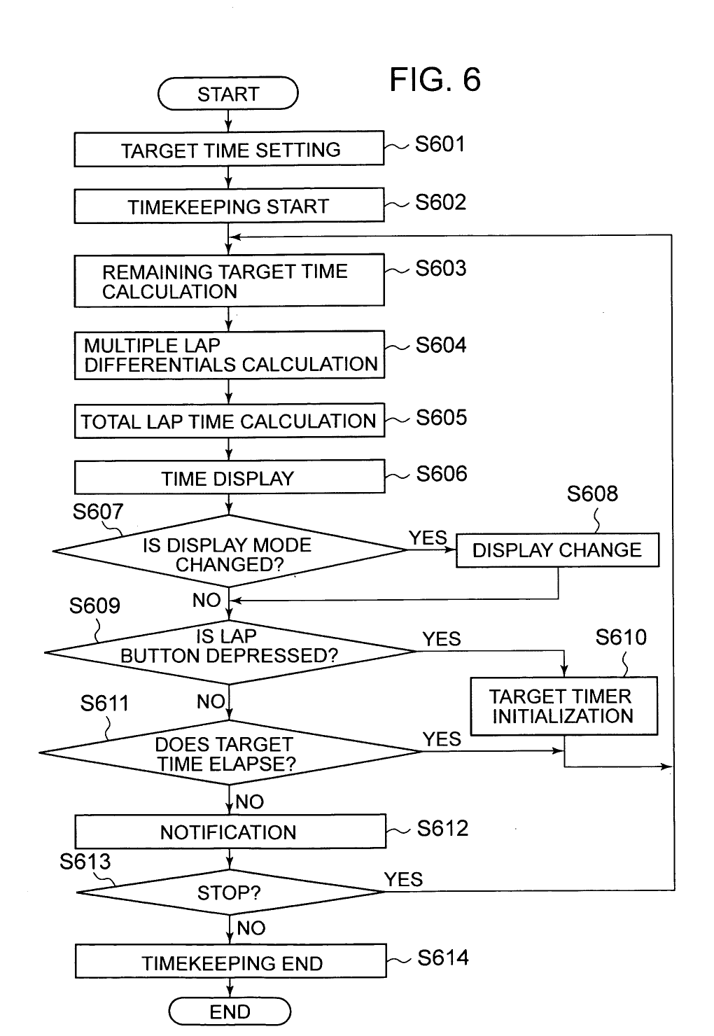

FIG. 6 is a flowchart that shows an example of the motion of the stopwatch 1 according to the present embodiment.

(Step S601) The target time is input from a user to the input portion 202 by the use of the buttons 11 to 14. The input portion 202 outputs the input target time to the control portion 301. The control portion 301 writes the target time, which is input from the input portion 202, onto the RAM 205. In addition, the target time may be common to each lap, and the different values may be set for each lap. After that, the process proceeds to step S602.

(Step S602) The button 11 (start) is depressed by a user, whereby, the input portion 202 outputs the signal indicating that the timekeeping is started to the control portion 301. The signal indicating that the timekeeping is started is input from the input portion 202 to the control portion 301. The control portion 301 initializes the time count numbers of the split count portion 305 and the lap count portion 302 to zero. The control portion 301 causes the split count portion 305 and the lap count portion 302 to start the timekeeping. The control portion 301 writes 1 on the lap number pointer that is recorded on the RAM 205 and indicates the current lap number. After that, the process proceeds to step S603.

(Step S603) The control portion 301 reads the target time from the RAM 205. The control portion 301 outputs the target time, which is read from the RAM 205, to the remaining target time calculation portion 303. The command, which outputs the lap elapsed time output from the control portion 301, is input to the lap count portion 302, and the lap count portion 302 outputs the lap elapsed time to the remaining target time calculation portion 303. The remaining target time calculation portion 303 calculates a value which subtracts the lap elapsed time (the remaining target time) from the target time by the use of the target time which is input from the control portion 301 and the lap elapsed time which is input from the lap count portion 302. The control portion 301 outputs the command, which outputs the remaining target time, to the remaining target time calculation portion 303. The remaining target time calculation portion 303 outputs the remaining target time to the control portion 301. After that, the process proceeds to step S604.

(Step S604) The control portion 301 reads the lap number pointer from the RAM 205. The control portion 301 reads the target time from the first to (the lap number pointer-1)th and the lap time from the first to (the lap number pointer-1)th from the RAM 205, and outputs the same to the differential detection portion 304. The differential detection portion 304 calculates the sum of the target times which are input from the control portion 301, and the sum of the lap times. The differential detection portion 304 calculates a value (multiple lap differentials) which subtracts the sum of the target times from the sum of the lap times. The control portion 301 outputs the command, which outputs the multiple lap differentials, to the differential detection portion 304. The differential detection portion 304 outputs the multiple lap differentials to the control portion 301. In addition, when the value of the lap number pointer is 1, the differential calculation is not performed. After that, the process proceeds to step S605.

(Step S605) The control portion 301 reads the lap number pointer from the RAM 205. The control portion 301 reads the lap time from the first to (the lap number pointer-1) from the RAM 205, and outputs the same to the total lap time calculation portion 306. The total lap time calculation portion 306 calculates the sum of the lap time (the total lap time) by the use of the lap time that is input from the control portion 301. The control portion 301 outputs the command, which outputs the total lap time, to the total lap time calculation portion 306. The total lap time calculation portion 306 outputs the total lap time to the control portion 301. In addition, when the value of the lap number pointer is 1, the total lap time calculation is not performed. After that, the process proceeds to step S606.

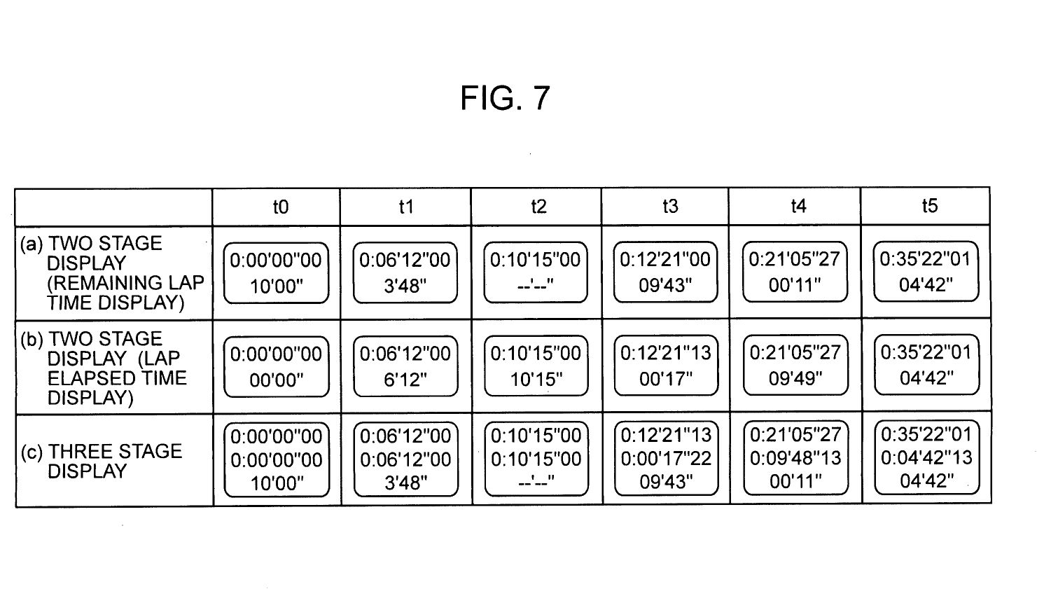

(Step S606) The control portion 301 outputs the command, which displays the current split time, the lap elapsed time, the remaining target time, the multiple lap differentials, the total lap time or the like, to the display portion 206. The command, which displays the current split time, the lap elapsed time, the remaining target time, the multiple lap differentials, the total lap time or the like, is input from the control portion 301 to the display portion 206, whereby the display portion 206 displays the current split time, the lap elapsed time, the remaining target time, the multiple lap differentials, the total lap time or the like. In addition, the details of the displaying method will be described using FIGS. 7 to 9. After that, the process proceeds to step S607.

(Step S607) The control portion 301 determines whether or not the display is changed based on information whether or not the button 13 is depressed. When it is determined that the display is changed (Yes), the process proceeds to step S608, and when it is not determined that the display is changed, the process proceeds to step S609.

(Step S608) The control portion 301 outputs the signal, which commands the display mode change, to the display portion 206. The display portion 206 receives the input of the signal, which commands the display mode change, from the control portion 301, and changes the display mode. In addition, after the button 13 is depressed, after a certain time elapses (for example, 10 seconds), the mode may automatically return to the display mode displayed before the button 13 is depressed. An example of the display mode to be displayed on the display portion 206 will be described below using FIGS. 7 to 9 shown below. After that, the process proceeds to step S609.

(Step S609) The control portion 301 determines whether or not the lap point is passed based on information whether or not the button 12 (the lap point passage) is depressed. When it is determined that the lap point is passed, the process proceeds to step S610. When it is not determined that the lap point is passed, the process proceeds to step S611.

(Step S610) The control portion 301 outputs the command which stops the timekeeping to the lap count portion 302. The command, which stops the timekeeping from the control portion 301, is input to the lap count portion 302, and the lap count portion 302 stops the timekeeping. The control portion 301 outputs the command, which outputs the lap time, to the lap count portion 302. The command, which outputs the lap time, is input from the control portion 301 to the lap count portion 302, and the lap count portion 302 outputs the lap time to the control portion 301. The control portion 301 writes the lap time, which is input from the lap count portion 302, on the RAM 205. The control portion 301 initializes the time count number of the lap count portion 302 to zero. The control portion 301 outputs the command, which starts the timekeeping, to the lap count portion 302. The command, which starts the timekeeping, is input from the control portion 301 to the lap count portion 302, and the lap count portion 302 starts the timekeeping. The control portion 301 reads the lap number pointer from the RAM 205. The control portion 301 writes a value, which adds 1 to the lap number pointer read from the RAM 205, on the RAM 205. After that, the process proceeds to step S603.

(Step S611) The control portion 301 determines whether or not the remaining target time calculated by the remaining target time calculation portion 303 is less than 0. When it is determined that the remaining target time is less than 0 (Yes), the process proceeds to step S612. When it is determined that the remaining target time is equal to or greater than 0 (No), the process proceeds to step S603.

(Step S612) The control portion 301 outputs the command, which performs the notification indicating that the target time has elapsed, to the notification portion 207. The command, which performs the notification indicating that the target time has elapsed, is input from the remaining target time calculation portion 303 to the notification portion 207, and the notification portion 207 performs the notification indicating that the target time has elapsed to a user through the sound notification. In addition, the notification is performed through the sound notification, but a method such as a vibration can also be used. After that, the process proceeds to step S613.

(Step S613) The control portion 301 determines whether or not the timekeeping is stopped based on information whether or not the button 11 (stop) is depressed. When it is determined that the timekeeping is stopped (Yes), the process proceeds to step S614. When it is not determined that the timekeeping is stopped (No), the process proceeds to step S603.

(Step S614) The control portion 301 outputs the command which stops the timekeeping to the split count portion 305. The command, which stops the timekeeping from the control portion 301, is input the split count portion 305, whereby the split count portion 305 stops the timekeeping. The control portion 301 outputs the command which stops the timekeeping to the lap count portion 302. The command, which stops the timekeeping from the control portion 301, is input to the lap count portion 302, whereby the lap count portion 302 stops the timekeeping. The control portion 301 outputs the command, which outputs the lap time, to the lap count portion 302. The command, which outputs the lap time, is input from the control portion 301 to the lap count portion 302, whereby the lap count portion 302 outputs the lap time to the control portion 301. The lap time, which is output from the lap count portion 302, is input to the control portion 301. The control portion 301 writes the lap time, which is input from the lap count portion 302, on the RAM 205. After that, the process proceeds to an ending process.

Next, an example of the display of the stopwatch 1 in the present embodiment will be described.

FIG. 7 is a schematic diagram that shows an example of the display of the display portion 206 in the stopwatch 1 according to the present embodiment. Times t0 to t5 in FIG. 7 are identical to times t0 to t5 in FIG. 4, respectively. A display (a) is an example of a case where information is displayed on the display portion 206 in two stages, a split time is displayed in an upper stage thereof and a remaining lap time is displayed in a lower stage thereof. A display (b) is another example of a case where information is displayed on the display portion 206 in two stages, the split time is displayed on an upper stage thereof, and the lap elapsed time is displayed on a lower stage thereof. A display (c) is an example of a case where information is displayed on the display portion 206 in three stages, the split time is displayed on the upper stage thereof, the lap elapsed time is displayed on a middle stage thereof, and the remaining lap time is displayed on a lower stage thereof. At the time t2, the remaining lap time is displayed as “--′--″”. This indicates that the target time has already elapsed.

A change in display mode in step S607 means that the display mode such as display (a) to (c) in FIG. 7 is changed.

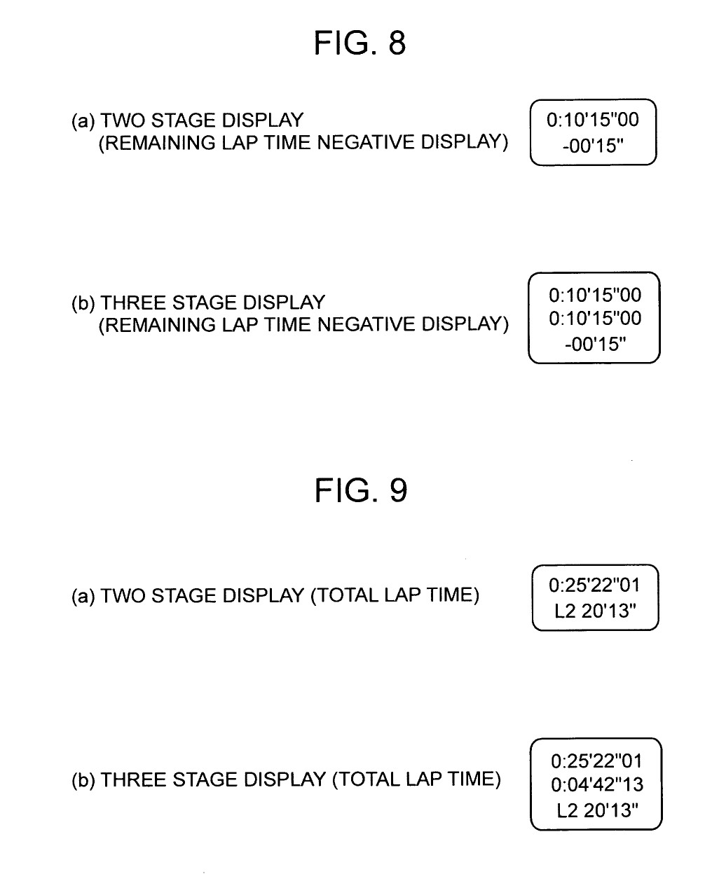

FIG. 8 shows another example of the display of the display portion 206 at the time t2 shown in FIG. 4. In a display (a), a display is indicated in which the target time is set to 10 minutes, and in the second stage, even if the target time elapses by 15 seconds, the button 12 (the lap point passage) is not yet depressed. In this case, the display of “--′--″” in the example of FIG. 7 is changed to the display of a value (in this case, a negative value) which subtracts the lap elapsed time from the target time. In a display (b), an example of three stage display is shown, the split time is displayed in the first stage, the lap elapsed time is displayed in the second stage, and a value (in this case, a negative value), which subtracts the lap elapsed time from the target time, is displayed in the third stage. In this manner, when the button 12 is not yet depressed even if exceeding the target time, by displaying the negative value which subtracts the lap elapsed time from the target time, a user can know by how long the time is delayed from a reached time to a predetermined lap point.

FIG. 9 shows another example of the display of the display portion 206 at a time t5 shown in FIG. 4. In a display (a), the split time is displayed in an upper stage, and the total lap time from the start to LAP-2 is displayed on a lower stage. In a display (b), the split time is displayed in an upper stage, the lap elapsed time is displayed in a middle stage, and the total lap time (a sum lap time) from the start to the LAP-2 is displayed in a lower stage. Similarly, instead of the total lap time (the sum lap time), the multiple lap differentials may be displayed. In this manner, by displaying the total lap time from the start to the LAP-n (n=1, 2, . . . ) or the multiple lap differentials, a user can know whether the time spent for the running of the section from the start to the LAP-n is longer or shorter than a predetermined time.

In this manner, according to the present embodiment, it is possible to simultaneously know the split time and the remaining target time without performing a switching operation of the screen. As a result, a user can know the current split time and an object reaching time up to the next lap point without performing a cumbersome operation.

Furthermore, according to the present embodiment, it is possible to simultaneously start the keeping of the split time and the keeping of the lap elapsed time (and the remaining target time). As a result, it is possible to exactly count the split time, the lap time, and the remaining target time without bothering user.

Furthermore, according to the present embodiment, the keeping of the lap elapsed time to a new lap is started simultaneously with the ending of the keeping of the lap elapsed time. As a result, a suitable target time to the new lap is set, whereby the measurement of the exact lap time is possible.

Additionally, according to the present embodiment, when the lap elapsed time passes the target time, the remaining lap time is not displayed, or when the lap elapsed time passes the target time, the passed time is displayed as a negative value. As a result, a user can know that it is impossible to pass the lap point within the target time.

Furthermore, according to the present embodiment, a difference between the sum of the target times and the sum of the lap times is displayed. As a result, a user is able to know a difference between the sum of the predetermined running times up to the previous lap and the running time up to the previous lap actually required.

In addition, the display of the multiple lap differentials may be displayed in the unit of a predetermined lap number such as 5 laps or 10 laps but not for each lap.

### Second Embodiment

Hereinafter, a second embodiment of the present embodiment will be described with reference to the drawings. A stopwatch (referred to as a stopwatch 2) of the present embodiment has the same exterior (FIG. 1) and configuration (FIGS. 2 and 3) as those of the stopwatch 1 in the first embodiment. Thus, even in the present embodiment, FIGS. 1, 2 and 3 used in the description of the first embodiment are used, and the description thereof will be omitted.

Next, an example of the motion of the stopwatch 1 (a timepiece device) in the present embodiment will be described.

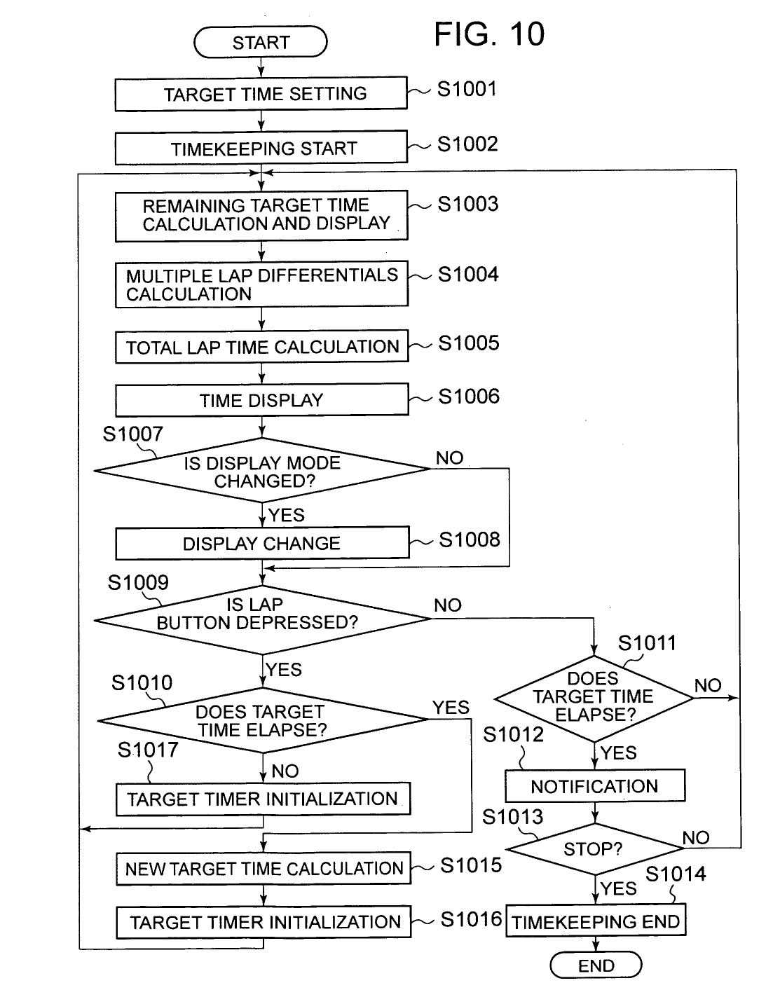

FIG. 10 is a flowchart that shows an example of the motion in the stopwatch 1 according to the present embodiment. In addition, since the respective processes of step S1001 to step S1009 and step S1011 to step S1014 are the same as those of step S601 to step S609 and step S611 to step S614 in the first embodiment (FIG. 6), the descriptions thereof will be omitted. However, the second embodiment is different from the first embodiment in that, when the determination of step S1009 is (Yes), the process proceeds to step S1010, when the determination of step S1009 is (No), the process proceeds to step S1011, when the determination of step S1011 is (No), the process proceeds to step S1003, and when the determination of step S1013 is (No), the process proceeds to step S1003.

(Step S1010) The control portion 301 determines whether the remaining target time calculated by the remaining target time calculation portion 303 is less than 0. When it is determined that the remaining target time is less than 0 (Yes), the process proceeds to step S1015. When it is determined that the remaining target time is equal to or greater than 0 (No), the process proceeds to step S1017.

(Step S1015) The control portion 301 outputs the command, which outputs the lap time, to the lap count portion 302. The command, which outputs the lap time, is input from the control portion 301 to the lap count portion 302, whereby the lap count portion 302 outputs the lap time to the control portion 301. The control portion 301 writes the lap time, which is input from the lap count portion 302, on the RAM 205. The control portion 301 reads the target time from the RAM 205. The control portion 301 calculates a value that subtracts the target time from the lap time. After that, the process proceeds to step S1016.

(Step S1016) The control portion 301 sets the time count number of the lap count portion 302 to a value that subtracts the target time from the lap time, calculated in step S1015. The control portion 301 outputs the command, which starts the timekeeping, to the lap count portion 302. The command, which starts the timekeeping, is input from the control portion 301 to lap count portion 302, and the count portion 302 starts the timekeeping. The control portion 301 reads the lap number pointer from the RAM 205. The control portion 301 writes a value, which adds 1 to the lap number pointer read from the RAM 205, onto the RAM 205. After that, the process proceeds to step S1003.

(Step S1017) The control portion 301 outputs the command, which outputs the lap time, to the lap count portion 302. The command, which outputs the lap time, is input from the control portion 301 to the lap count portion 302, and the lap count portion 302 outputs the lap time to the control portion 301. The control portion 301 writes the lap time, which is input from the lap count portion 302, onto the RAM 205. The control portion 301 initializes the time count number of the lap count portion 302 to zero. The control portion 301 causes the lap count portion 302 to start the timekeeping. The control portion 301 reads the lap number pointer from the RAM 205. The control portion 301 writes a value, which adds 1 to the lap number pointer read from the RAM 205, onto the RAM 205. After that, the process proceeds to step S1003.

By the motion of FIG. 10, the stopwatch 2 is used as below. Upon passing the lap point, when the target time has already elapsed, the stopwatch 2 starts the timekeeping by setting a value, which subtracts the time, at which the lap time exceeds the target time, from the predetermined target time, as a new target time.

In this manner, according to the present embodiment, when the lap elapsed time passes the target time, the stopwatch 2 starts the measurement of a new lap elapsed time. That is, when the lap time exceeds the target time, the stopwatch 2 starts the timekeeping by setting a value, which subtracts the excess time from the next target time, as a new target time. As a result, the stopwatch 2 displays the remaining target time shorter than the originally set target time by the time exceeded in the last lap, whereby a user is encouraged to make up the deficit in a new lap.

In addition, the program for realizing the functions is recorded in a computer-readable recording medium and the program recorded in the recording medium is read and executed by a computer system, whereby all or a part of functions of each portion included in the stopwatch 1 or 2 in the embodiments mentioned above may be realized. In addition, “the computer system” mentioned herein includes an OS and hardware, such as peripheral devices.

Furthermore, “the computer-readable recording medium” refers to a portable medium such as a flexible disk, an optical magnetic disc, ROM, and CD-ROM, and a storage unit such as a hard disk equipped in the computer system. Furthermore, “the computer-readable recording medium” may include a medium which dynamically holds the program for a short period, such as a communication line of a case of transmitting the program via a network such as the Internet or a communication line such as a phone line, and a medium which holds the program for a certain time, such as a volatile memory in the inner portion of the computer system becoming a server or a client of that case. Furthermore, the program may be a program for realizing a part of the functions mentioned above, and may be a program in which the functions mentioned above can be realized by the combination with the program recorded in the computer system in advance.

The embodiments of the present invention were described in detail with reference to the drawings, but the specific configuration is not limited to those mentioned above, and various design changes or the like can be made within the scope not departing from the gist of the present invention.

What is claimed is:

1. A timepiece device comprising:
a first time measurement portion which measures an elapsed time from a first timekeeping start operation; and
a second time measurement portion which measures an elapsed time from a second timekeeping start operation,
wherein a time measured by the first time measurement portion, and a time, which is a time measured by the second time measurement portion subtracted from an object time, are displayed on the display portion in a combined manner.

2. The timepiece device according to claim 1,
wherein the first time measurement portion starts the measurement of time, and the second time measurement portion simultaneously starts the measurement of time.

3. The timepiece device according to claim 1,
wherein the second time measurement portion starts a new measurement of time simultaneously with an ending operation of the measurement of the time of the second time measurement portion.

4. The timepiece device according to claim 2,
wherein the second time measurement portion starts a new measurement of time simultaneously with an ending operation of the measurement of the time of the second time measurement portion.

5. The timepiece device according to claim 1,
wherein, when a time, which is the time kept by the second time measurement portion subtracted from the object time, is a negative value, the time, which is the time kept by the second time measurement portion subtracted from the object time, is displayed as the negative value.

6. The timepiece device according to claim 2,
wherein, when a time, which is the time kept by the second time measurement portion subtracted from the object time, is a negative value, the time, which is the time kept by the second time measurement portion subtracted from the object time, is displayed as the negative value.

7. The timepiece device according to claim 3,
wherein, when a time, which is the time kept by the second time measurement portion subtracted from the object time, is a negative value, the time, which is the time kept by the second time measurement portion subtracted from the object time, is displayed as the negative value.

8. The timepiece device according to claim 4,
wherein, when a time, which is the time kept by the second time measurement portion subtracted from the object time, is a negative value, the time, which is the time kept by the second time measurement portion subtracted from the object time, is displayed as the negative value.

9. The timepiece device according to claim 1,
wherein the second time measurement portion starts a new timekeeping when the object time elapses.

10. The timepiece device according to claim 2,
wherein the second time measurement portion starts a new timekeeping when the object time elapses.

11. The timepiece device according to claim 3,
wherein the second time measurement portion starts a new timekeeping when the object time elapses.

12. The timepiece device according to claim 4,
wherein the second time measurement portion starts a new timekeeping when the object time elapses.

13. The timepiece device according to claim 5,
wherein the second time measurement portion starts a new timekeeping when the object time elapses.

14. The timepiece device according to claim 6,
wherein the second time measurement portion starts a new timekeeping when the object time elapses.

15. The timepiece device according to claim 7,
wherein the second time measurement portion starts a new timekeeping when the object time elapses.

16. The timepiece device according to claim 8,
wherein the second time measurement portion starts a new timekeeping when the object time elapses.

17. The timepiece device according to claim 1,
wherein a value, which is a sum of the times measured by the second time measurement portion subtracted from a sum of the object times, is displayed.

18. The timepiece device according to claim 2,
wherein a value, which is a sum of the times measured by the second time measurement portion subtracted from a sum of the object times, is displayed.

19. An electronic apparatus which includes the timepiece device according to claim 1.

20. A program for causing a computer of a timepiece device to execute first time measurement means for measuring an elapsed time from a first timekeeping start operation, second time measurement means for measuring an elapsed time from a second timekeeping start operation, and means for displaying a time measured by the first time measurement portion and a time, which is a time measured by the second time measurement portion subtracted from an object time, on the display portion in a combined manner.
